(19) United States
(12) Patent Application Publication
(10) Pub. No.: US 2004/0046065 A1
(43) Pub. Date: Mar. 11, 2004

(54) Watering hose having vibrating lids for spray holes

(76) Inventor: In Yul Jeong, Seoul (KR)

Correspondence Address: DARBY & DARBY P.C., P. O. BOX 5257, NEW YORK, NY, 10150-5257, US

(21) Appl. No.: 10/235,088

(22) Filed: Sep. 4, 2002

(51) Int. Cl. B05B 1/20

(52) U.S. Cl. 239/566

(57) ABSTRACT

Disclosed is a watering hose having vibrating lids which enables a distance, which water sprayed through spray holes formed through the watering hose reaches, to change according to change of a spray pressure of the water and restoring forces of the vibrating lids. The watering hose has a plurality of spray holes perforated through an outer surface of the watering hose. The watering hose includes a plurality of vibrating lids which cover over the spray holes, respectively. The vibrating lids change a pressure of water sprayed through the spray holes, thereby changing a distance which the water reaches. The watering hose can prevent spray pressure from being largely reduced, thereby enabling water to be evenly sprayed to either near or far places.

### BACKGROUND OF THE INVENTION

1. Field of the invention

The present invention relates to a watering hose having vibrating lids for spray holes, and more particularly to a watering hose having vibrating lids which enables a distance, which water sprayed through spray holes formed through the watering hose reaches, to change according to change of spray pressure of the water and restoring forces of the vibrating lids.

2. Description of the Prior Art

An ordinary hose is widely used in irrigation for cultivation. In general, water supplied from a water supply source by a motor and the like is transferred to a desired place through the hose and sprayed on plants by a separate spray means. Especially, instead of the separate spray means, a watering hose may be used so as to supply the transferred water directly to crops or lawn.

Usually, the watering hose has a construction in which water under a predetermined pressure in the hose is sprayed through spray holes formed through the wall of the watering hose. In the watering hose having such a construction, one or more spray holes are spaced at regular intervals to form a group, and such groups are arranged along the watering hose, so that water can be sprayed through the groups of the spray holes.

However, in a conventional watering hose having spray holes formed along opposite side portions, since the spraying pressure or water through the spray holes rapidly decreases as the location of the spray holes grows farther from the water supply source, it is difficult to transfer water to a location far from the water supply source. Therefore, in order to transfer water to a location far from the water supply source, it is necessary to employ a high-pressure water-supplying apparatus or an additional pressurizing apparatus disposed at an intermediate position along the watering hose, which increase not only the number of elements of the watering hose but also the expense for irrigation by the watering hose.

Further, when the water supply pressure is increased in order as to prevent the spraying pressure from being lost even in a distanced location, the increased pressure may expand portions of the watering hose around the spray holes, thereby lowering the spray pressure or even tearing the watering hose in an extreme case.

In order to solve these problems, a watering hose as shown in FIG. 8 has been disclosed. Referring to FIG. 8, a nonwoven fabric 56 is contained in a watering hose 50 made from vinyl. When water is filled in the watering hose 50, the nonwoven fabric 56 is deflected toward one semi-cylindrical side 52, so that the water introduced in the hose is not directly sprayed through spray holes 58 but passes through gaps of the nonwoven fabric 56 so that the pressure of the water is reduced. That is, the nonwoven fabric 56 reduces the pressure of the water sprayed through the spray holes 58, so as to prevent the high pressure of water in the watering hose 50 from being directly applied to the portions around the spray holes 58, thereby preventing the portions around the spray holes 58 from being expanded or torn.

In the disclosed watering hose as described above, although the nonwoven fabric 56 can prevent the watering hose 50 from being expanded or torn, the spraying pressure is not maintained but is considerably reduced, so that the water cannot be evenly sprayed on both far and near areas but is sprayed on the near area. Further, although said one semi-cylindrical side 52 to which a water pressure reduced by the nonwoven fabric 56 is applied is not expanded or torn in spite of the spray holes 58 formed through said one semi-cylindrical side 52, the other semi-cylindrical side 54 of the watering hose 50 is subjected to a relatively high pressure so that the other semi-cylindrical side 54 may be expanded or torn.

Further, in the above-mentioned spray hoses, the water is not sprayed in the form of mist and directly on plants, but may reach rear surfaces of leaves after bouncing up from the ground. In this case, various germs contained in the soil are carried by the water and come to cling to the leaves, thereby contaminating the leaves and causing the leaves to be afflicted with diseases.

### SUMMARY OF THE INVENTION

Accordingly, the present invention has been made to solve the above-mentioned problems occurring in the prior art, and an object of the present invention is to provide a watering hose having vibrating lids for spray holes, which can prevent spray pressure from being abruptly reduced, thereby enabling water to be evenly sprayed to either near or far places.

It is another object of the present invention to provide a watering hose having vibrating lids for spray holes, the restoring force of which changes according to pressure change in the watering hose, thereby enabling water to be evenly sprayed to either near or far places.

It is another object of the present invention is to provide a watering hose having vibrating lids for spray holes, which can spray water in the form of mist, so as to prevent germs in the soil from being carried up by the splashing water and contaminating the watered plants.

In order to accomplish this object, there is provided a watering hose having a plurality of spray holes perforated through an outer surface of the watering hose, the watering hose comprising a plurality of vibrating lids which cover over the spray holes, respectively, the vibrating lids changing the pressure of water sprayed through the spray holes, thereby changing a distance which the water reaches.

The vibrating lids are arranged in a longitudinal direction, and each of the vibrating lids may have a scale shape or a cross shape.

Further, it is preferred that the watering hose comprises a woven fabric layer and polyethylene coating layers coated on inner and outer surfaces of the woven fabric layer, and that a high-density coating layer is coated on the inner surface of the woven fabric layer.

### BRIEF DESCRIPTION OF THE DRAWINGS

The above and other objects, features and advantages of the present invention will be more apparent from the following detailed description taken in conjunction with the accompanying drawings, in which:

FIG. 1 is a longitudinal section of a watering hose having vibrating lids for spray holes according to a preferred embodiment of the present invention;

FIG. 2 is a transverse section of a spray pressure control assembly employed in the watering hose shown in FIG. 1;

FIG. 3 is a perspective view showing the laminated construction of a watering hose having vibrating lids for spray holes according to the preferred embodiment of the present invention;

FIG. 4A is a longitudinal section of the watering hose shown in FIG. 1, for showing the operation of the vibrating lids and the path through which the water is sprayed;

FIG. 4B is a longitudinal section a watering hose according to another embodiment of the present invention, in which spray holes are formed along two side portions opposed to each other;

FIG. 5 is a side view of a watering hose according to another embodiment of the present invention, in which each spray hole is formed in a shape of the letter “X”;

FIG. 6 is a side view showing a sprayed shape of water through the watering hose having the construction shown in FIG. 5;

FIG. 7A is a longitudinal section of a watering hose having vibrating lids for spray holes according to another preferred embodiment of the present invention, in which each of the spray holes has a shape of a slit like the letter “I”;

FIG. 7B is an enlarged view of the portion A in FIG. 7A; and

FIG. 8 is a transverse section of a conventional watering hose containing a nonwoven fabric.

### DETAILED DESCRIPTION OF THE PREFERRED EMBODIMENTS

Hereinafter, preferred embodiments of the present invention will be described in detail with reference to the accompanying drawings.

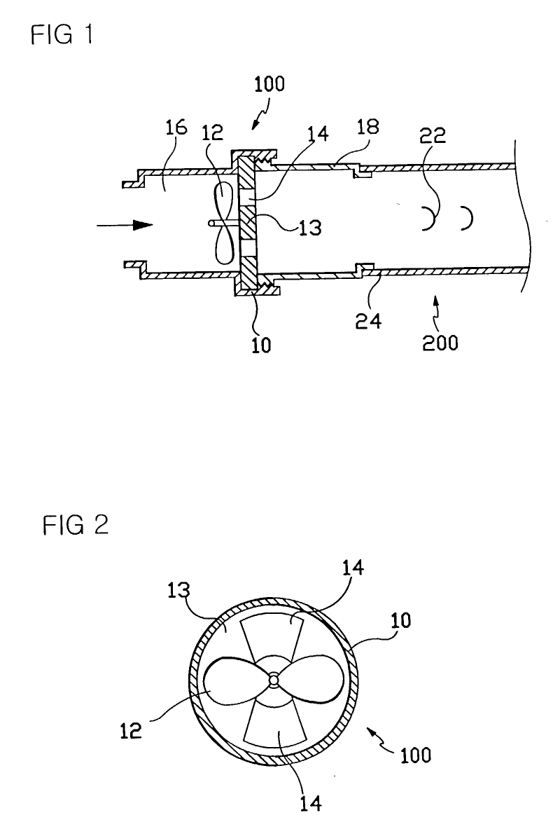

Referring to FIG. 1, in a watering hose 200 having vibrating lids for spray holes according to a preferred embodiment of the present invention, a plurality of spray holes, through which fluid is sprayed out of the watering hose 200, are formed along one side portion of the watering hose 200. A spray pressure control assembly 100 is assembled with a portion of the watering hose 200, through which fluid is supplied to the watering hose 200, and controls the pressure of the fluid sprayed from the watering hose 200 to periodically change according to the passage of time.

The watering hose 200 includes a hose body 24, a plurality of spray holes 26 formed along one side portion of the watering hose 200, and a plurality of vibrating lids 22 formed over the spray holes 26, which open or close the spray holes 26 according to the pressure change in the hose body 24. It is preferred that the vibrating lids 22 are located at a level of a middle and upper portion of the watering hose 200 and that each of the vibrating lids 22 has a scale shape or an inverse scale shape, so that the vibrating lids 22 allow the fluid to be sprayed out of the hose body 24 to near or far areas according to the pressure change of the fluid in the hose body 24.

The spray pressure control assembly 100 has an assembly housing 10 which includes an introduction section 16 and a discharge section 18 assembled with each other by screws and the like. Further, the spray pressure control assembly 100 includes a partition 13 and a fan 12 contained in the assembly housing 10. The partition 13 has passing holes 14 formed through the partition 13, and the fan 12 is fixed to the partition 13.

According to the present invention, the watering hose 200 may have not only the construction described above but also various other shapes and constructions which can supply water to an object.

Referring to FIG. 2 which is a front view of the spray pressure control assembly 100 employed in the watering hose 200 according to the preferred embodiment of the present invention, the partition 13 is formed inside of the assembly housing 10, and the passing holes 14 are formed through the partition 13 and located symmetrically to each other. Further, the fan 12 rotating about a longitudinal axis of the assembly housing 10 is fixed to the partition 13, so that the fan 12 repeatedly opens and covers the passing holes 14 while rotating periodically. Especially, the rotation of the fan 12 causes the pressure of the fluid supplied to the watering hose 200 to repeatedly alternate between a pressurized state and released or pressure-reduced state, thereby causing the spray pressure of the fluid sprayed through the spray holes 26 out of the watering hose 200 to change according to passage of time. This means that the spray pressure of the fluid sprayed against the vibrating lids 22 and the restoring force of the vibrating lids 22 change according to passage of time. As a result, the fluid can be evenly sprayed on both near and far areas, that is, on a wide area regardless of the distance from the watering hose.

In this case, the rotation of the fan 12 can be controlled by various methods. For example, although the fan 12 may have the construction described above, the fan 12 may be assembled with a motor, actuator, and the like, and a rotating speed of the fan 12 or an opening degree of the vibrating lids 22 may be controlled by a separate means, so that the pressure of the fluid supplied to the watering hose 200 can be controlled.

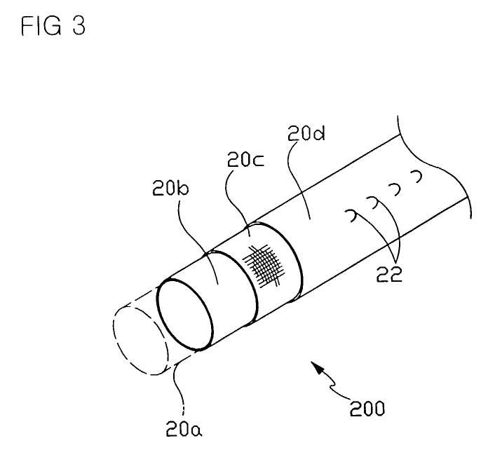

FIG. 3 is a perspective view showing the laminated construction of a watering hose having vibrating lids for spray holes according to the preferred embodiment of the present invention.

As shown, the watering hose 200 includes a fluid-contact layer 20a serving as an innermost layer through which the fluid is supplied, and a high-density coating layer 20b, a woven polyethylene fabric layer 20c, and a low-density coating layer 20d, which are laminated in sequence outside of the fluid-contact layer 20a.

The vibrating lids 22 are formed along a side portion of the watering hose 200, which is disposed at a predetermined height from the ground when the watering hose 200 has been placed to be used in watering. In this case, the vibrating lid 22 can be formed in various ways, that is, the vibrating lids 22 may be formed in a preform sheet and the preform sheet may be manufactured into the watering hose by adhering edges of the preform sheet to each other, or a hose without the vibrating lids 22 may be manufactured and the vibrating lids 22 may then be formed in the hose by a laser or other manufacturing means, so that the watering hose 200 can be manufactured.

The high-density coating layer 20b and the low-density coating layer 20d are formed at the inner and outer layers of the watering hose 200, respectively, thereby increasing the restoring force of the vibrating lids 22.

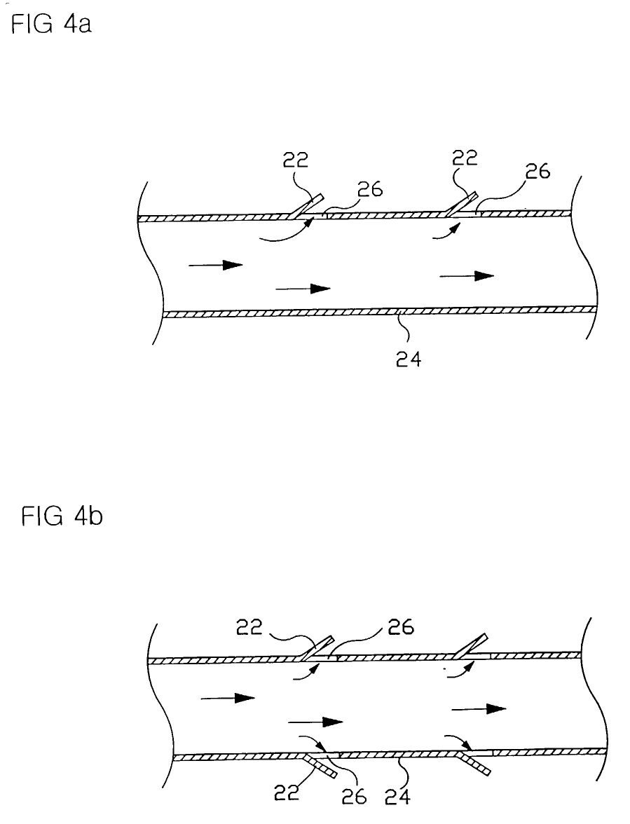

Further, FIG. 4A shows a longitudinal section of the watering hose 200 according to the present invention, in which one side of the hose body 24 of the watering hose 200 is cut out and the vibrating lids 22 and the spray holes 26 are formed through the cut-out portion. In the watering hose 200 as shown, the fluid introduced in the hose body 24 is sprayed through the spray holes 26 by a predetermined pressure formed in the hose body 24. In this case, when the pressurized fluid is supplied, the vibrating lids 22 are spaced away from and open the spray holes 26 as widely as possible, so as to allow the fluid to be sprayed to farther distances. In contrast, when the fluid with a reduced pressure is supplied, the restoring force of the vibrating lids 22 causes the vibrating lids 22 to return nearer to and slightly close the spray holes 26, so as to allow the fluid to be sprayed to a more adjacent area.

Further, FIG. 4B shows a modified construction of a watering hose 200 in which spray holes 26 are formed along two side portions opposed to each other. In the watering hose 200 having the construction described above, the fluid, the spray pressure of which changes according to passage of time, can be sprayed toward both sides of the watering hose 200, that is, the fluid can be evenly sprayed on a wider area.

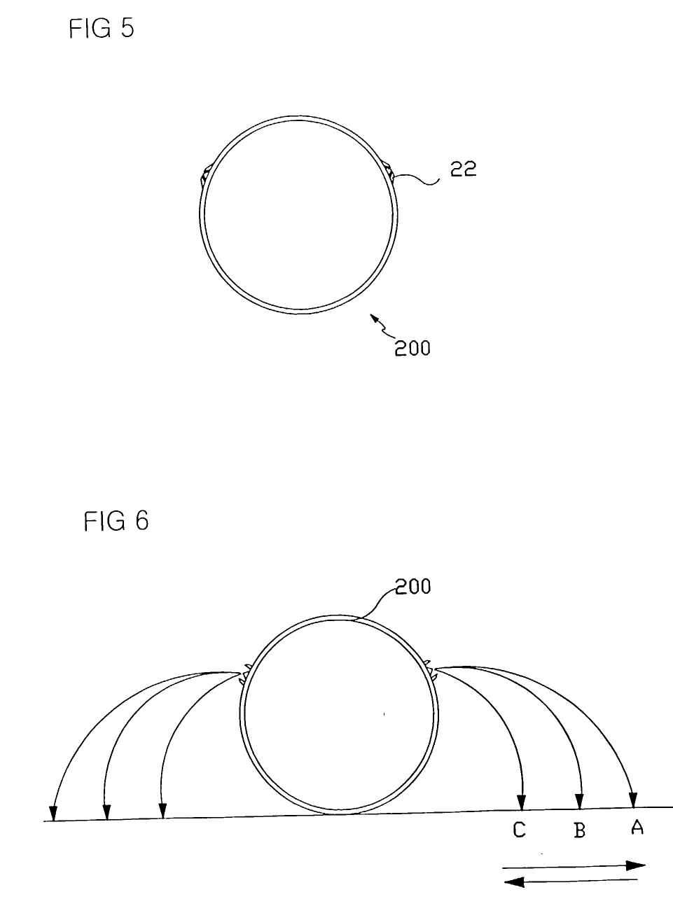

Further, FIG. 5 shows another modified construction of the watering hose 200 according to the present invention, in which each of the spray holes is formed in a cross shape, that is, a shape of the letter “X”. In addition, the vibrating lids 22 may have various shapes such as shapes of the letter “U” or “V”, or the like. In other words, there is no limitation to the shapes of the vibrating lids 22.

In the above description, various constructions for facilitating the pressure control by the spray pressure control assembly 100 are shown and described as examples. Differently from the constructions described above, it goes without saying that the spray holes may be formed through the hose body 24 without the vibrating lids 22.

FIG. 6 shows a resultant shape of the water sprayed through the watering hose having the construction shown in FIG. 5.

Referring to FIG. 6, it is shown that the distance the sprayed fluid reaches changes according to the pressure change in the watering hose 200. That is, when the passing holes 14 (see FIG. 2) are completely open and the spray pressure has highest value, the fluid reaches the farthest position A. Thereafter, when the passing holes 14 are covered by the fan 12 according to the rotation of the fan 12 and the pressure formed in the watering hose 200 is reduced to the minimum value, the location the fluid reaches changes from position A through position B to position C. Thereafter, when the fan 12 further rotates and the passing holes 14 are opened again, the pressure in the watering hose 200 increases again and the location the fluid reaches changes again from C through B toward A.

When the spray pressure of the fluid and the distance the fluid reaches change according to the passage of time in this way, the fluid can be evenly sprayed on or supplied to a broad area.

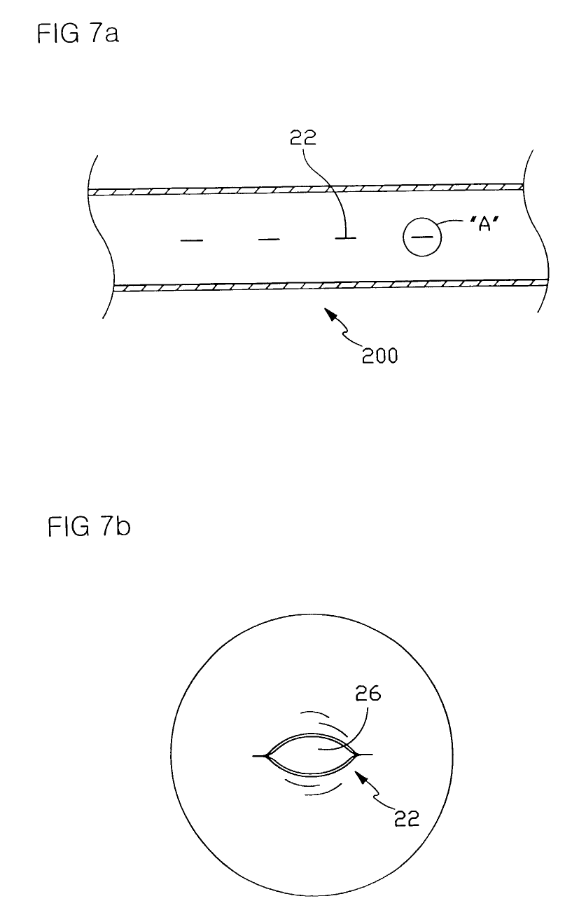

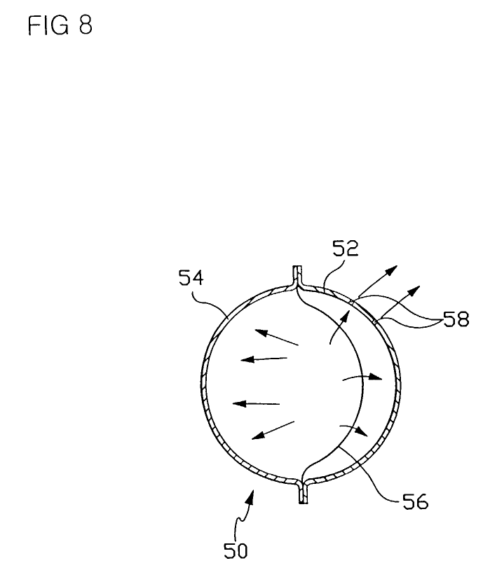

FIGS. 7A and 7B show a watering hose having vibrating lids for spray holes according to another preferred embodiment of the present invention, in which each of the spray holes has a shape of a slit like the letter “I”.

The spray holes 26 formed along a side portion of the watering hose 200 are normally closed. When water is filled and a predetermined pressure is formed in the watering hose 200, the water is sprayed through the spray holes 26. In this case, as shown in FIG. 7B which is an enlarged front view of the “A” portion in FIG. 7A, a peripheral portion around the spray hole 26 serves as the vibrating lid 22, and the water is sprayed through the spray hole 26 against the vibrating lid 22. In this case, the vibrating lid 22 has a tendency to maintain its unexpanded state and applies resistance to the spray or discharge of the water, so that the vibrating lid 22 starts to vibrate. As a result, the vibration of the vibrating lid 22 enables the water to be sprayed in the form of mist not in the form of a water stream through portions near side ends of the spray hole 26 where the hose body starts to be cut to form the spray hole 26. Further, the water is sprayed farther through a central portion of the spray hole 26, since a portion of the vibrating lid 22 around the central portion of the spray hole 26 applies a smaller resistance to the spray or discharge of the water, in comparison with a portion of the vibrating lid 22 around the side ends thereof.

In the watering hose having the construction described above according to the present embodiment, the water is supplied in the shape of mist or fine water drops, thereby not only preventing branches or leaves of plants from being damaged by the supplied water but also preventing plants from being contaminated by germs which may be carried by water bouncing up from the ground. These effects may be achieved also by the watering hose having the scale-shaped or cross-shaped vibrating lids.

In the watering hose according to the present invention, vibrating lids prevent the spray pressure from being abruptly reduced, thereby enabling water to be sprayed and supplied to a distanced area.

Further, in the watering hose according to the present invention, the restoring force of the vibrating lids changes according to the pressure change in the watering hose, so as to control the distance the sprayed water reaches, thereby enabling the water to be evenly sprayed on a broad area.

Also, in the watering hose according to the present invention, the pressure of the fluid introduced into the watering hose is periodically changed, so that the distance the sprayed water reaches is periodically changed, thereby enabling the water to be evenly sprayed on a broad area.

Moreover, in the watering hose according to the present invention, the water is sprayed in the form of mist or fine water drops, so that plants are prevented from being contaminated by germs which may be carried by water bouncing up from the ground.

Although several preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A watering hose having a plurality of spray holes perforated through an outer surface of the watering hose, the watering hose comprising a plurality of vibrating lids which cover over the spray holes, respectively, the vibrating lids changing a pressure of water sprayed through the spray holes, thereby changing a distance which the water reaches.

2. A watering hose as claimed in claim 1, wherein the vibrating lids are arranged in a longitudinal direction, each of the vibrating lids having a scale shape.

3. A watering hose as claimed in claim 1, wherein the vibrating lids are arranged in a longitudinal direction, each of the spray holes being cut in a cross shape, so that each of the vibrating lids has a cross shape.

4. A watering hose as claimed in claim 1, wherein the spray holes are arranged in a longitudinal direction, each of the spray holes being cut in a shape of a letter “I”, so that portions each surrounding each of the spray holes function as the vibrating lids.

5. A watering hose as claimed in claim 1, wherein the watering hose comprises:
a woven fabric layer; and
polyethylene coating layers coated on inner and outer surfaces of the woven fabric layer.

6. A watering hose as claimed in claim 5, wherein the polyethylene coating layers comprise a high-density coating layer coated on the inner surface of the woven fabric layer.
